(19) United States
(12) Patent Application Publication
(10) Pub. No.: US 2015/0129007 A1
(43) Pub. Date: May 14, 2015

(54) Locking Pull Ring For A Folding Canopy

(71) Applicant: Hong Ting Zhou, Ningbo (CN)

(72) Inventor: Hong Ting Zhou, Ningbo (CN)

(21) Appl. No.: 14/462,489

(22) Filed: Aug. 18, 2014

(30) Foreign Application Priority Data
Nov. 13, 2013 (CN) 201320722751.5

(51) Int. Cl. E04H 15/46; F16B 19/00

(52) U.S. Cl. CPC E04H 15/46; F16B 19/00
USPC 135/140; 29/428

(57) ABSTRACT

A portable shelter framework is described, having a locking pin that can quickly and easily connect to a pull ring. Specifically, the locking pin includes a slot or groove that the ring can be moved into, allowing solid or non-helical pull rings to be used.

### RELATED APPLICATIONS

This application claims priority Chinese Utility Model Application No. 201320722751.5 filed Nov. 13, 2013, entitled Pull Pin Ring Structure For Folding Canopy, which is hereby incorporated herein by reference in its entirety.

### BACKGROUND OF THE INVENTION

The evolution of light-weight, easily erected and economical portable shelters has led to the increasing commercial and private use of these structures. Portable shelters typically employ a cloth or plastic material attached to a light-weight, highly foldable skeleton or frame structure. The cloth provides a roof and/or walls for the shelter, and the frame structure provides support for the cloth, for example, the frame structure includes legs to elevate the roof and a system of trusses to support the roof and to generally stabilize the shelter. The frame structure often incorporates a compound, scissor-like, arrangement of a light-weight, tubular material such as aluminum. In order to maximize the usable area under a shelter, the frame structure is often designed so that the roof is supported solely by legs positioned near the perimeter of the roof. Stated alternatively, shelters do not typically employ an interior supporting post or leg such as a leg or post positioned in the center of shelter. U.S. Pat. No. 4,641,676 to Lynch, U.S. Pat. No. 7,367,348 to Tsai, and, and U.S. Pub. No. 20120048319 to Dotterweich, the contents of which are herein incorporated by reference, are examples of such portable shelters.

Some prior art frame structures used simple pins, such as push-pin or pull pin mechanisms to releasably support a frame structure in its expanded configuration. While these mechanisms typically provide adequate support, the relatively heavy weight of the upper portions of the framework can make them difficult to push or pull when trying to fold up the structure. Additionally, these pins are typically located in close proximity to sliding members and therefore, when pressed/pulled, can result in pinching or damage to a user's hand.

### SUMMARY OF THE INVENTION

The present invention is directed to an improved locking pin for a sliding connector of a foldable portable shelter framework. Specifically, the locking pins of the present invention allow for a pull ring to more quickly and easily be added during the manufacturing process.

In one embodiment, a locking pin is provided with a slot extending along the length of the pin and opening along opposite sides of the pin. An opening that is generally perpendicular to the slot (i.e., an overall “L” shaped slot) allows a pull ring to easily enter the slot.

In another embodiment, a locking pin has a slot that from near a first end, all the way through to the tip of the pin. The pull ring can be advance into the slot from the locking pin's tip.

In another embodiment, a locking pin has a groove shaped to accept a pull ring. A cover member engages or couples to the pin, over the groove. Thus, the pull ring can be easily place in the groove and locked in place by the cover member.

The present invention is also directed to a method of connecting a pull ring to a locking pin without opening or otherwise passing any portion of the locking pin through an opening in the circumference of the ring.

### BRIEF DESCRIPTION OF THE DRAWINGS

These and other aspects, features and advantages of which embodiments of the invention are capable of will be apparent and elucidated from the following description of embodiments of the present invention, reference being made to the accompanying drawings, in which

FIG. 1 is a perspective view of a portable shelter framework according to the present invention;

FIG. 2 is a magnified view of Area A in FIG. 1;

FIG. 3 illustrates a prior art locking pin;

FIG. 4 illustrates an embodiment of a locking pin according to the present invention;

FIG. 5 illustrates an embodiment of a locking pin according to the present invention;

FIG. 6 illustrates an embodiment of a locking pin according to the present invention; and,

FIG. 7 illustrates the locking pin of FIG. 6 within a sliding connector.

### DESCRIPTION OF EMBODIMENTS

Specific embodiments of the invention will now be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the embodiments illustrated in the accompanying drawings is not intended to be limiting of the invention. In the drawings, like numbers refer to like elements.

One embodiment of the present invention is directed to a framework for supporting a covering (e.g., cloth, fabric, plastic, etc.) on its top portion and having sliding connectors that can be selectively engaged via a lever member. These sliding connectors allow the framework to be more safely and easily engaged and disengaged to/from and expanded position.

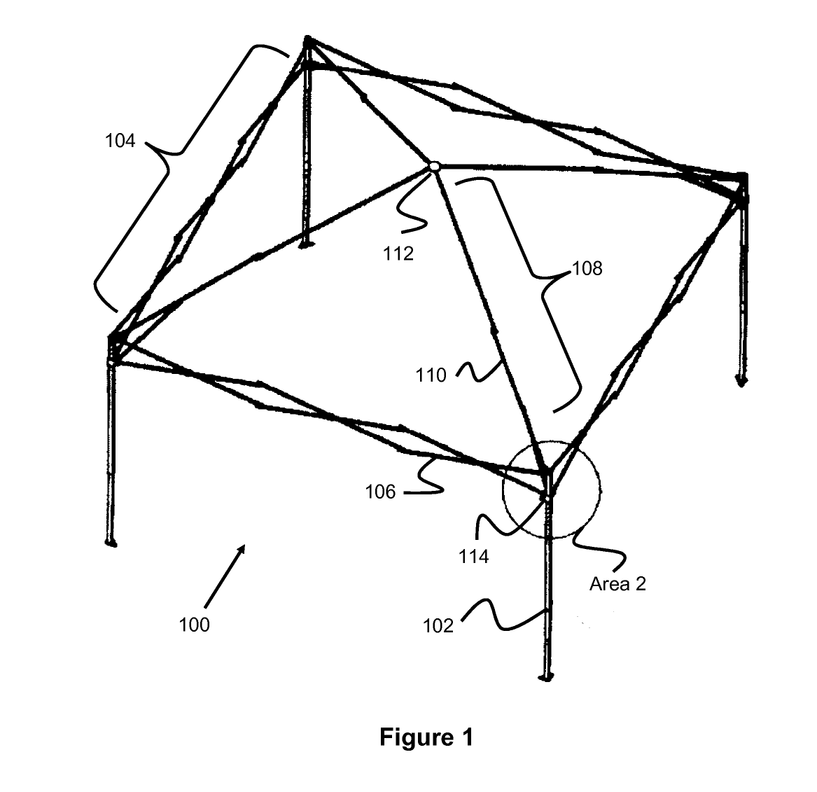

FIG. 1 illustrates one example of a framework 100 according to the present invention, though almost any other shelter frameworks with a sliding connector can also be used in connection with the present invention. This example framework 100 includes four elongated leg members 102 that support the top of the framework 100 from the ground when expanded. Each leg member 102 is connected to two other legs via scissor linkages 104, which are each composed of a plurality of pivotally connected, elongated, frame members 106. Each of the leg members 102 are also connected to a center hub connector 112 via folding linkage 108, which is further composed of a plurality of elongated, pivotally connected frame members 110.

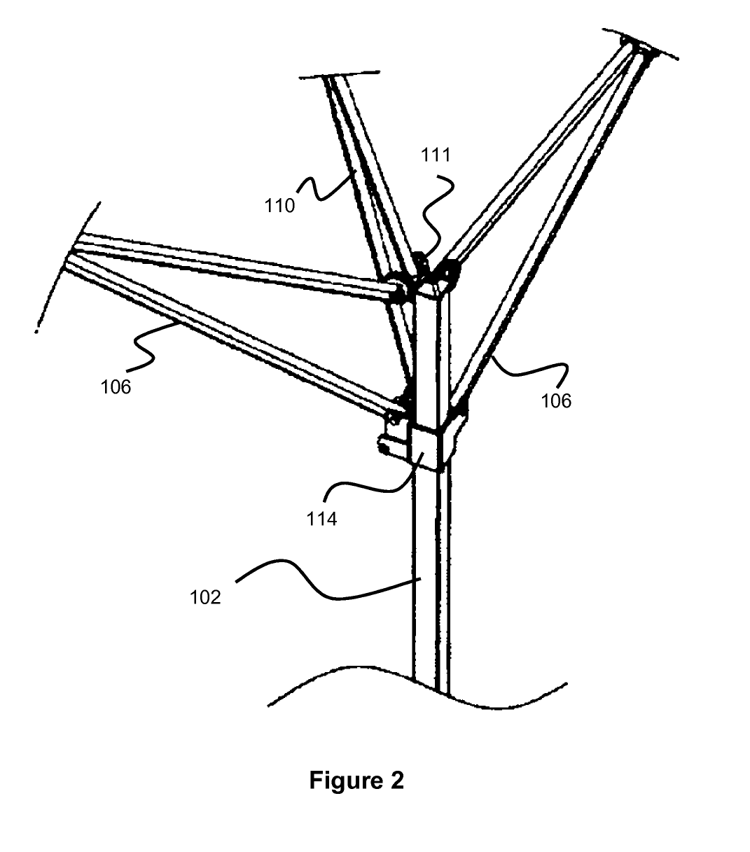

As best seen in FIG. 2, when the framework 100 is in a fully expanded position, a sliding connector 114 is locked at or near an upper end of the leg member 102. When the framework 100 is compressed or folded up, the sliding connector 114 is unlocked from the upper end of the leg member 102 and slid downwardly where it optionally may have a second locking location to help lock the framework 100 in its compress configuration. Since the sliding connector 114 connects to two members 106 and one member 110 (and fixed connector 111 also connects to two members 106 and one member 110), its movement along the leg member 102 either extends or retracts linkages 104, 108.

The sliding connector 114 can be locked in by a locking pin located within the sliding connector 114 and sliding into and out of an aperture in the leg member 102. These locking pins can be spring-biased into a locking position, maintaining the sliding connector 114 in the locked position until pulled outwards by a user.

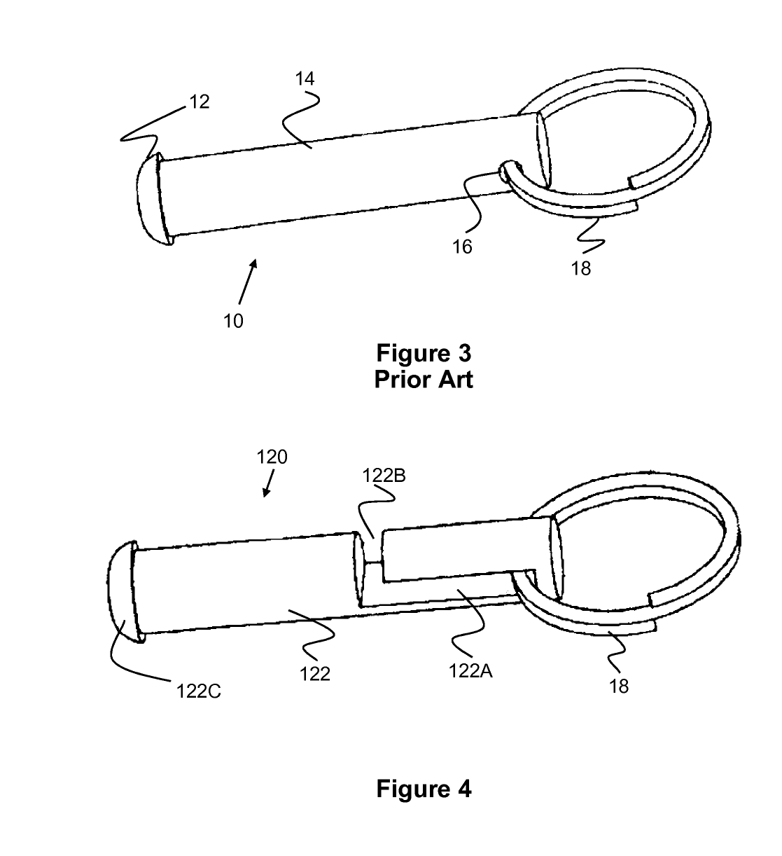

FIG. 3 illustrates a prior art design for a locking pin 10, having an elongated body portion 14, a flanged tip portion 12, an aperture 16, and a helical or spiral pull ring 18. Typically, these pull rings are the same or similar to key rings used to group door keys. Even with relatively thin objects, like door keys, rings such as the pull ring 18 can be difficult to open up sufficiently to slide through an aperture. Since several locking pins 10 can be used in a canopy framework such as the framework 100, assembly of these locking pins 10 may require a significant amount of time.

FIG. 4 illustrates an embodiment of a locking pin 120 according to the present invention which allows for quick connection of a pull ring 18. Specifically, its body portion 122 includes a longitudinal slot 122A with an opening 122B at the inner end of the slot 122A. In this respect, the ring 18 can be passed through opening 122B and moved into slot 122A, allowing pulling motion on the ring 18 to pull against an outer end of the slot 122A. Furthermore, unlike the prior art locking pin design, the pull ring 18 can be a solid, non-helical ring since the locking pin 120 facilitates the connection, not any mechanism of the ring 18 (e.g., the helical structure).

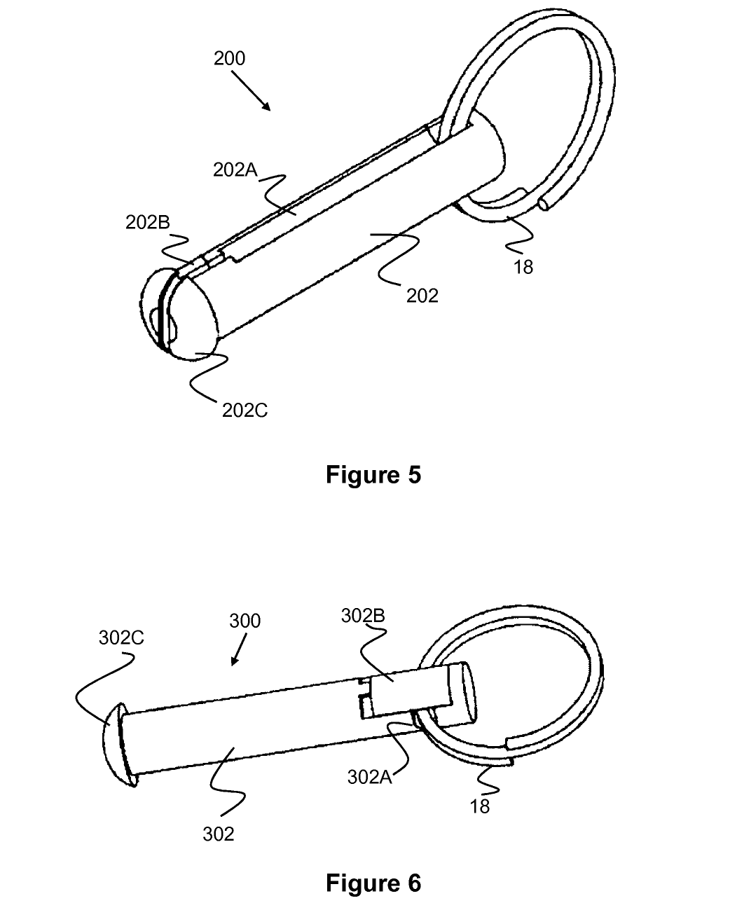

FIG. 5 illustrates another embodiment of a locking pin 200 having a slot that extends the entire length of the body 202. In the present example embodiment, the groove has a larger-width groove portion 202A, which is sized to accommodate the pull ring 18, and a small-width groove portion 202B that extends through the flanged tip 202C. Hence, the pull ring 18 can be quickly pushed through the groove portion 202B and into the portion 202A.

FIG. 6 illustrates yet another embodiment of a locking pin 300 in which the body portion 302 includes a depression or groove 302A. A cover member 302B is shaped to connect or snap over the groove 302A, preventing the ring 18 from leaving the groove 302A. Hence, the user can simply place the ring 18 in the groove 302A and snap on the cover member 302B. The cover member 302B can couple to the body portion 302 via physical engagement structures (e.g., detents or mating surfaces), adhesives, or a combination of both.

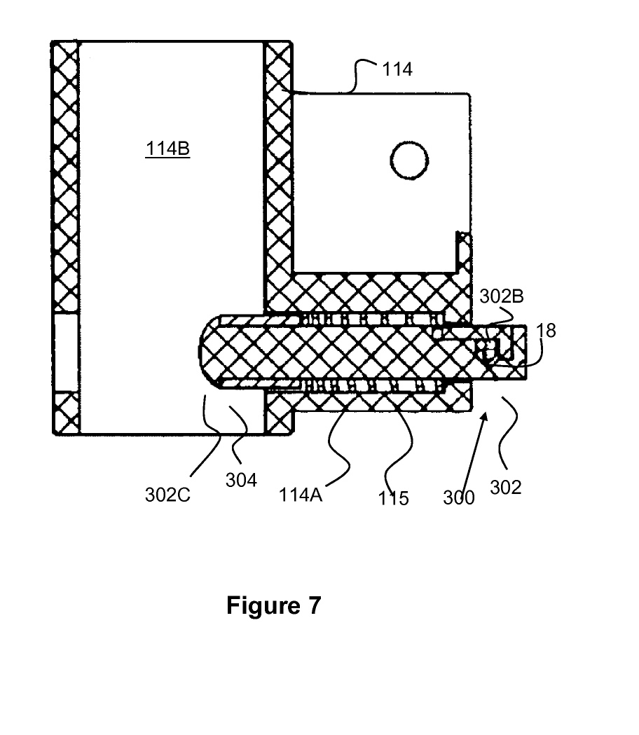

FIG. 7 illustrates an example of how the locking pin 300 (and any of the other locking pins described in this specification) engages with the sliding connector 114. Specifically, the locking pin 300 is located within a space or compartment 114A and surrounded by a spring 115. The spring 115 abuts against an inner surface of the compartment 114A and the tubular spacer 304. The tubular spacer 304, in turn, abuts against the flanged tip 302C (or flanged tips 202C or 122C in the case of the other embodiments in this specification). In this respect, the spring 115 biases the locking pin 300 into the vertical interior passage 114B of the sliding connector 114. Additionally, the pull ring 18 may act as a “stop” to prevent the locking pin from passing too far into the sliding connector 114.

In operation, the user expands the framework 100 and slides the sliding connector 114 upwards on the leg member 102. Since the leg member 102 passes through the vertical interior passage 114B, an aperture on the leg member 102 can be aligned with the opening of the compartment 114A. Since the locking pin 300 is spring-biased towards the passage 114B, the alignment allows the locking pin 300 to move into the aperture of the leg member 102, thereby locking the sliding connector 114 relative to the leg member 102. When the user desires to unlock the sliding connector 114, the pull ring 18 is pulled, moving the locking pin 300 out of the aperture of the leg member 102.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A portable shelter framework comprising:
a plurality of elongated members connected to each other so as to form a folded and an unfolded portable shelter framework;
a sliding connector that is connected to at least one of said plurality of elongated members; and,
a locking pin having an elongated body and a pull ring engagement portion shaped to connect to a pull ring without opening said pull ring.

2. The portable shelter framework of claim 1, wherein said pull ring engagement portion is a slot.

3. The portable shelter framework of claim 1, wherein said pull ring engagement portion is a slot extending completely through said locking pin and having an opening connecting to said slot.

4. The portable shelter framework of claim 3, wherein said slot and said opening form an L-shape.

5. The portable shelter framework of claim 2, wherein said slot extends through a tip of said locking pin.

6. The portable shelter framework of claim 1, wherein said pull ring engagement portion comprises a groove located on said locking pin, and a cover shaped to connect over said groove.

7. The portable shelter framework of claim 6, wherein said groove is arc-shaped.

8. The portable shelter framework of claim 6, further comprising adhesive securing said cover over said groove.

9. The portable shelter framework of claim 1, wherein said locking pin is located within a locking pin passage of said sliding connector and can further move into and out of a leg member passage.

10. A portable shelter framework comprising:
a plurality of elongated members connected to each other so as to form a folded and an unfolded portable shelter framework;
a sliding connector that is connected to at least one of said plurality of elongated members;
a locking pin movable within said sliding connector; said locking pin having a pull ring engagement portion having an open portion sized to allow a passage of a pull ring; and,
a pull ring located in said ring engagement portion.

11. The portable shelter framework of claim 10, wherein said ring engagement portion is a slot extending through said locking pin.

12. The portable shelter framework of claim 11, wherein said open portion connects to said slot.

13. The portable shelter framework of claim 11, wherein said slot and said open portion form an L shape.

14. The portable shelter framework of claim 11, wherein said open portion is an end of said slot located at a tip of said locking pin.

15. The portable shelter framework of claim 10, wherein said ring engagement portion is a depression on a side of said locking pin.

16. The portable shelter framework of claim 15, wherein said pull ring is located within said depression and further comprising a cover connectable over said depression.

17. A method of assembling a locking assembly of a portable shelter framework, comprising:
providing a locking pin having a slot;
moving a pull ring through an opening of said slot of said locking pin without opening up a circumference said pull ring; and,
placing said locking pin in a sliding connector.

18. The method of claim 17, wherein said opening is located on a side of said locking pin.

19. The method of claim 17, wherein said opening is located at a tip of said locking pin.
